(19) United States
(12) Patent Application Publication
(10) Pub. No.: US 2017/0121152 A1
(43) Pub. Date: May 4, 2017

(54) ELEVATOR SYSTEM

(71) Applicant: ThyssenKrupp Elevator AG, Essen (DE)

(72) Inventors: Holger Zerelles, Leinfelden-Echterdingen (DE); Bernd Altenburger, Neuhausen (DE); Ronald Dietze, Böblingen (DE); Juri Schäfer, Stuttgart (DE)

(73) Assignee: ThyssenKrupp Elevator AG, Essen (DE)

(21) Appl. No.: 15/301,720

(22) PCT Filed: Mar. 31, 2015
(86) PCT No.: PCT/EP2015/057077

§ 371 Date: Oct. 4, 2016

(30) Foreign Application Priority Data
Apr. 8, 2014 (DE) 10 2014 105 003.7

(51) Int. Cl. B66B 11/02; B66B 9/00

(52) U.S. Cl. CPC B66B 11/022; B66B 9/00; B66B 2201/306

(57) ABSTRACT

A lift system may include at least two cars that can be moved in a lift shaft, at least two drives each of which is configured to drive one of the cars for movement within the lift shaft, and a frame device. The at least two cars may be positioned within the frame device that is movable in the lift shaft. The at least two cars can be moved relative to one another within the frame device by way of their respective drives.

The present invention relates to a lift system and to a method for operating a lift system having at least two cars which can be moved in a lift shaft, having at least two drives, each of the drives being set up to drive in each case one of the cars in the lift shaft.

### PRIOR ART

Double-decker car systems have a lift cage with two cars. The said two cars are arranged in a common catching frame. A double-decker car system has a drive, by means of which the entire lift cage and therefore both cars can be moved at the same time in a lift shaft. The said drive is usually configured as a traction sheave drive. The entire lift cage is usually connected here to a counterweight via suspension means.

Double-decker drives of this type for double-decker car systems are usually very solid and have a high weight and a high space requirement. Furthermore, double-decker drives of this type are associated with a high cost outlay. Double-decker drives are very expensive to purchase, have high power consumption and are associated with high maintenance costs.

Here, the two cars of a double-decker car system are coupled mechanically to one another and are therefore connected to one another fixedly. Here, the spacing between the two cars cannot be changed or can be changed only by way of complicated adjusting apparatuses. However, a displacement of the two cars relative to one another is desirable, for example in order for it to be possible to compensate for different floor heights in a building.

Adjusting apparatuses of this type are to be provided in addition to the double-decker drive. The said adjusting apparatuses are usually arranged as active elements between the two cars. For example, adjusting apparatuses of this type can comprise hydraulic elements or gearwheels.

The spacing between the cars of a double-decker car system is possible only with relatively great outlay even by means of adjusting apparatuses of this type.

The invention is therefore based on the object of moving or adjusting two cars flexibly relative to one another in a lift shaft, without it being necessary here for the above-described disadvantages of a double-decker car system to be accepted.

### DISCLOSURE OF THE INVENTION

According to the invention, a lift system and a method for operating a lift system having the features of the independent patent claims are proposed. Advantageous refinements are the subject-matter of the subclaims and of the following description.

The lift system according to the invention comprises at least two cars which can be moved in a common lift shaft. Here, each of the said cars is assigned a dedicated drive. The individual drives of the lift system are set up to drive in each case one of the cars for movement within the lift shaft.

At least two cars of the lift system are arranged within a frame device which can be moved in the shaft. The cars of the lift system which are arranged within the frame device can be moved firstly within the lift shaft by means of their respective drives and can here also secondly be displaced relative to one another within the frame device. The frame device is expediently connected rigidly to one of the cars.

The drives in each case comprise, in particular, an appropriate motor. The individual drives are configured, in particular, as traction sheave drives and/or linear drives. However, other suitable drives are also conceivable. The individual drives can be operated or actuated, in particular, by means of appropriate power units. Here, a dedicated independent power section can be provided, for example, for each drive. As an alternative or in addition, a power section can also be provided which operates a plurality of, in particular all, drives independently of one another.

Here, the frame device can surround or border the individual cars at least partially. Here, the frame device does not necessarily have to be closed within itself, but rather, in particular, can also comprise openings. However, a closed embodiment of the frame device or else a closed frame device with a closable opening is also conceivable. The frame device can comprise, in particular, a suspension means mounting, in order to fasten an appropriate suspension means, and a catching apparatus as safety apparatus for protecting against dropping of the cars.

The individual cars within the frame device represent one unit of cars which can be moved jointly in the lift shaft. Here, the cars within the frame device are coupled to one another (at least partially).

### ADVANTAGES OF THE INVENTION

By means of the invention, a suitable number of cars can be arranged within the common frame device and can be moved relative to one another in a simple way within the said frame device. In contrast to a double-decker car system, in which two cars can be moved relative to one another within a common catching frame only in an extremely complicated manner to a limited extent, the cars of a lift system according to the invention can be moved relative to one another flexibly and simply.

As a result of the individual drives which are assigned to the individual cars, each car is moved by way of an individual drive. In order to move the entire unit comprising cars which are arranged within the common frame device in the lift shaft, the individual drives are actuated jointly. Here, the drives are actuated in such a way that the individual cars are moved synchronously in the lift shaft. Drives of this type for moving individual cars can be realized inexpensively and with low structural outlay. It is less expensive to realize an individual drive for each car than a large common drive for jointly moving the complete unit of cars, as is the case in a double-decker car system. In contrast to a double-decker drive of this type, individual drives for the individual cars are substantially more efficient, can be realized less expensively and can be operated using less power.

Furthermore, the individual cars can be moved relative to one another flexibly by means of the individual drives. Here, the individual drives of the individual cars are actuated individually and not synchronously. Complicated additional adjusting apparatuses are therefore not required, as is the case in a double-decker car system. The spacing of the cars from one another can be set flexibly to an appropriate value. There is not the problem here that a defined minimum floor spacing has to be maintained between the individual cars. Furthermore, the spacing of the cars from one another can therefore be adapted flexibly to different floor spacings or floor heights.

The relative movement of the cars with respect to one another is limited by way of the common frame device. Here, the cars can be moved relative to one another only up to a maximum spacing defined by the frame device. Furthermore, the cars are moved relative to one another, in particular, only at a comparatively low speed or relative speed. The risk of a collision of the cars with one another can therefore be avoided by way of simple means. Complicated safety mechanisms are therefore not required. Complicated collision prevention devices are not required, in particular.

In particular, an appropriate coupling mechanism can be provided, in order to couple individual cars fixedly to one another. By means of the said coupling mechanism, the spacing between the cars can be set fixedly. In particular, parts of the said coupling mechanism can be arranged on the individual cars. Here, the coupling between individual cars can be, in particular, a mechanical and/or electromagnetic coupling.

In particular, the invention is suitable for arranging two cars within the frame device. Two cars can therefore be moved jointly in an analogous manner with respect to a double-decker car system, but with very much less outlay than in the case of a double-decker car system. Two drives for two cars are less expensive and more space-saving than one double-decker drive. Furthermore, an additional adjusting apparatus is not required for moving the two cars relative to one another.

Each of the cars is preferably assigned a suspension means, for example a suspension cable or a suspension belt. The said suspension means are preferably guided along the frame device. Here, the suspension means are guided, in particular, within the frame device, but can also be guided outside the frame device. By means of the suspension means, the individual cars are connected, in particular, to the respective drive. In particular, the frame device has a suitable suspension means guide for this purpose. In particular, a suspension means of an uppermost car is fastened to the frame device itself, in particular to a suspension means mounting of the frame device. The suspension means of the remaining cars are guided along the frame device, in particular within the frame device. The suspension means of one specific car is therefore guided past the remaining cars. In particular, the suspension means are guided on the frame device in such a way that the suspension means do not make contact with the remaining cars.

The suspension means therefore cannot strike the individual cars or influence them negatively. Furthermore, suspension means movements or suspension means oscillations cannot occur (for example, cable movements or cable oscillations in the case of suspension cables). Suspension means movements or suspension means oscillations of this type limit the conveying height or the vertical transport heights of lift systems, in which a plurality of cars are moved in one lift shaft. The said problem that suspension means movements or suspension means oscillations can occur can be eliminated by way of the suspension means guide along the frame device. A great conveying height can therefore be achieved by way of the lift system according to the invention.

The suspension means are preferably guided along the frame device in such a way that they are combined in a centered or at least substantially centered manner in an upper region of the lift shaft. The said upper region of the lift shaft is configured here, in particular, as a shaft top. In particular, appropriate rollers or roller arrangements are arranged in the said upper region. The suspension means are combined by means of the said rollers or roller arrangements. The suspension means are guided from the respective drives to the rollers or roller arrangements and are deflected by means of the rollers or roller arrangements and are guided to the respective cars.

By virtue of the fact that all the suspension means are combined in a substantially centered manner in the upper region of the lift shaft, the suspension means are also fed in a substantially centered manner to the drives. Forces which are exerted by way of the suspension means therefore also act in a substantially centered manner on the drives.

Furthermore, it can be prevented in this way that forces which are exerted on the frame device by way of the suspension means act inhomogeneously on the frame device. The individual cars are therefore suspended in a particularly stable manner and can be guided quietly and with high travelling comfort.

The suspension means of the uppermost car is attached to the frame device, in particular, in an (at least substantially) centered manner in the upper region. The remaining suspension means are guided from the drives in an (at least substantially) centered manner into the upper region of the lift shaft to the rollers or roller arrangements and are deflected by way of the latter. In particular, the suspension means are deflected in such a way that they are guided along the frame device to the respective associated car.

Car guide elements are preferably arranged within the frame device between the individual cars and the frame device. The cars which are arranged within the frame device can be moved along the said car guide elements. In particular, guide elements of this type are configured as a sliding guide. Here, in particular, suitable guide rollers are arranged on the cars (or on the outer sides of the cars) and corresponding guide rails are arranged on the frame device (or on the inner side of the frame device).

In particular, if two cars are arranged within the frame device, it is suitable to arrange car guide elements within the frame device only for one of the two cars. The said car can then be moved relative to the other car along the car guide elements. Here, in particular, an upper one of the said two cars is connected fixedly to the frame device. A lower one of the two cars can be moved relative to the upper car along the car guide elements.

A frame device guide is advantageously arranged within the lift shaft, in particular between a wall of the lift shaft and the frame device. The cars which are arranged within the frame device can be moved jointly within the lift shaft along the said frame device guide. In particular, the said frame device guide is configured as a sliding guide. In particular, suitable guide rollers are arranged on the frame device (or on the outer sides of the frame device), and corresponding guide rails are arranged in the lift shaft. The frame device and therefore the cars within the frame device are moved along the said frame device guide. Here, the drives of the cars are actuated jointly, in particular. Here, the cars are moved synchronously in the lift shaft.

The lift system preferably has at least two counterweights. Each of the cars is connected to one of the counterweights. Here, in particular, each of the cars is connected to the respective counterweight via the corresponding suspension means, furthermore, in particular, via the respective drive. Here, the counterweights are connected in each case to the respective car, in particular, with a cable suspension ratio of 1:1 or 2:1.

In one preferred refinement of the invention, at least the second of the counterweights is arranged within the first of the counterweights. The said second counterweight can be moved within the said first counterweight. In an analogous manner to the cars which can be moved within a common frame device, counterweights can be moved within a superordinate counterweight. All counterweights are arranged, in particular, inside one another. Only one track for the counterweights is therefore required, in particular, in the lift shaft.

In particular, this refinement is suitable for two cars within the frame device with a total of two counterweights. Here, a smaller, second counterweight can be moved, in particular, within a larger, first counterweight. For more than two counterweights, it is particularly suitable to always combine two counterweights as one unit of this type. The counterweights are therefore combined to form counterweight pairs, one of the said counterweight pairs being arranged movably within the other of the said counterweight pairs.

The second counterweight can further preferably be moved within the first counterweight along internal counterweight guide elements. The said internal counterweight guide elements are arranged within the first counterweight, between the second counterweight and the first counterweight. In particular, the internal counterweight guide elements are configured analogously with respect to the car guide elements, in particular as a sliding guide.

External counterweight guide elements are further preferably arranged within the lift shaft, in particular between a wall of the lift shaft and the first counterweight. The counterweights which are arranged inside one another can be moved jointly within the lift shaft along the said external counterweight guide elements. In particular, the external counterweight guide elements are configured analogously with respect to the frame device guide, in particular as a sliding guide.

In one advantageous refinement of the invention, at least one of the cars can be removed from the frame device. Here, the said at least one car can be dismantled from the frame device. Here, in particular, the said at least one car is taken out of operation. For this purpose, the frame device has an appropriate opening. Here, in particular, the frame device is open or can be opened on its underside. The respective cars are dismantled from the frame device through the said opening. In particular, the unit of cars is moved onto a specific removal floor or a specific alternative stopping place. In particular, the said removal floor is an uppermost or lowermost floor of the lift system. The corresponding number of cars is removed from the frame device on the said removal floor and is stored on the removal floor.

A fixing element is further preferably set up to fix the suspension means which are assigned to the removed cars to the lift shaft. In particular, the said suspension means are likewise dismantled or removed from the frame device. If the respective cars are removed, the respective suspension means are no longer guided along the frame device. It is therefore ensured that the suspension means of the removed cars do not strike the remaining cars in the frame device or the frame device itself. Suspension means movements or suspension means oscillations of the removed cars are therefore also avoided and a high conveying height of the frame device with the remaining cars can be ensured.

In each case one passive buffer element is preferably arranged between the individual cars within the frame device. In particular, a predefined minimum spacing between the cars within the frame device is ensured by means of the said passive buffer element. Here, the passive buffer element is not an active element which is actuated for moving the cars relative to one another.

In one preferred refinement of the invention, the frame device is configured as a lift cage frame of one of the cars (called a first car in the following text). A lift cage frame of this type comprises, in particular, a catching frame with guide elements of the frame device guide, a suspension means mounting and a catching apparatus. The suspension means mounting is arranged, in particular, in an upper region of the lift cage frame. The suspension means of the first car, in particular, is attached to the suspension means mounting. The catching apparatus is a safety apparatus for protecting against dropping of the car or the cars and optionally also for securing the counterweight of the first car or the counterweights of all cars. A catching apparatus of this type can be triggered, for example, by a speed limiter as soon as clear overshooting of an operational speed is present. The first car is, in particular, inserted into the lift cage frame and is connected fixedly to the latter. The remaining cars can therefore be moved relative to one another in the lift cage frame of the first car. In one particularly preferred refinement of the invention, two cars are arranged within one lift cage frame. A second car is therefore arranged in the lift cage frame of the first car.

Furthermore, the invention relates to a method for operating a lift system. Refinements of the said method according to the invention result from the above description of the lift system according to the invention in an analogous manner.

In particular, a lift system according to the invention is operated by means of a method according to the invention. In particular, a computing unit, for example a control unit, is set up, in particular in terms of program technology, to carry out a method according to the invention and to actuate the lift system correspondingly.

The implementation of the method in the form of software is also advantageous, since this causes particularly low costs, in particular if an executing control unit is also used for further tasks and is therefore present in any case. Suitable data storage media for providing the computer program are, in particular, diskettes, hard drives, flash memory, EEPROMs, CD-ROMs, DVDs, and the like. A download of a program via computer networks (Internet, intranet, etc.) is also possible.

Further advantages and refinements of the invention result from the description and the appended drawing.

It goes without saying that the features which are mentioned above and are still to be explained in the following text can be used not only in the respectively specified combination, but rather also in other combinations or on their own, without departing from the scope of the present invention.

The invention is shown diagrammatically in the drawing using one exemplary embodiment and will be described in detail in the following text with reference to the drawing.

### DESCRIPTION OF THE FIGURE

FIG. 1 shows one preferred refinement of a lift system according to the invention in a diagrammatically simplified illustration.

FIG. 1 diagrammatically shows one preferred refinement of a lift system according to the invention and denotes it with 100. The lift system 100 is set up to carry out one preferred embodiment of a method according to the invention.

The lift system 100 has a first car 110 and a second car 120 which can be moved in a common lift shaft 101. For the sake of clarity, the common lift shaft 101 is shown merely diagrammatically. The lift system 100 can also have a different appropriate number of cars, for example three, four, five or more.

The first car 110 and the second car 120 are arranged within a frame device 200. In this example, the frame device 200 is configured as a lift cage frame 200 of the first car 110. The first car 110 is therefore connected rigidly to the lift cage frame 200.

A suspension means mounting 111 is arranged in an upper region 205, in particular in a roof element of the frame device 200. A first suspension means 112 is attached or fastened to the said suspension means mounting 111. The first suspension means 112 is configured, for example, as a suspension cable or as a suspension belt. Here, the suspension means mounting 111 is arranged in a centered manner in the upper region 205 of the frame device 200, and the first suspension means 112 therefore acts in a centered manner on the frame device 200.

The first car 110 is driven by means of an appropriate first drive, for example by means of a first traction sheave drive 113. The first traction sheave drive 113 is connected via the first suspension means 112 to the frame device 200 and therefore to the first car 110.

Furthermore, the first car 110 is connected via the first suspension means 112 and the first traction sheave drive 113 to a first counterweight 301.

The second car 120 is driven by means of a second drive, for example by means of a second traction sheave drive 123. The second car 120 is connected via a second suspension means 122 to the second traction sheave drive 123. The second suspension means 122 is, for example, likewise configured as a suspension cable or as a suspension belt.

A roller arrangement comprising a plurality of guide rollers 121a is arranged in an upper region 105 of the lift shaft 101, in particular at a shaft top of the lift shaft 101. By means of the said guide rollers 121a, the second suspension means 122 is combined in a substantially centered manner in the upper region 105 of the lift shaft 101.

Furthermore, the second suspension means 122 is guided along the frame device 200. In this example, the second suspension means 122 is guided within the frame device 200, but it is also conceivable that the second suspension means 122 is guided outside the frame device 200. The second suspension means 122 is deflected by means of the guide rollers 121a and is guided past the first car 110 to the second car 120 by means of an appropriate suspension means guide. The suspension means guide comprises, in particular, quasi-static rollers 121b which are arranged on the second car.

The frame device 200 serves as a guide for the second suspension means 122. The second suspension means 122 therefore cannot strike the first car 110 and cannot have suspension means oscillations or suspension means movements imparted to it.

Furthermore, the second car 120 is connected via the second suspension means 122 and the second traction sheave drive 123 to a second counterweight 302.

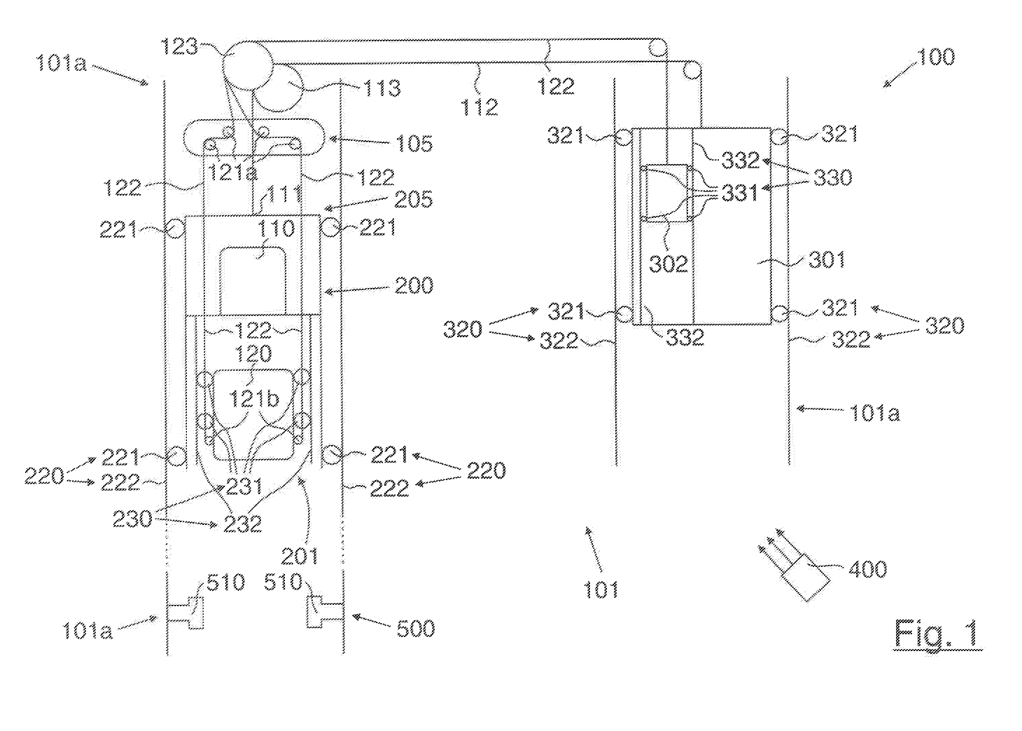

FIG. 1 shows a 1:1 suspension of a first lift car 110 and a first counterweight 301 and of a second lift car 120 and a second counterweight 302, but a 2:1 suspension is also conceivable in each case.

Each of the two traction sheave drives 113 and 123 is set up to drive in each case one of the cars 110 and 120. The traction sheave drives 113 and 123 specifically and the lift system 100 generally are actuated by a control unit 400 which is shown merely diagrammatically in FIG. 1. The control unit 400 is set up to carry out one preferred embodiment of a method according to the invention.

By means of the traction sheave drives 113 and 123, the cars 110 and 120 can firstly be actuated jointly or as one unit. Here, both traction sheave drives 113 and 123 are actuated jointly by the control unit 400, in order that the cars 110 and 120 are moved synchronously in the lift shaft 101. Here, the cars 110 and 120 are moved together with the frame device 200 in the lift shaft 101.

For this purpose, a frame device guide 220 is arranged within the lift shaft 101. The said frame device guide 220 is configured as a sliding guide or roller guide and comprises guide rails 222 which are arranged, in particular, on a shaft wall 101a of the lift shaft 100, and guide rollers 221 which are arranged, in particular, on the frame device 200.

By means of the traction sheave drives 113 and 123, the cars 110 and 120 can secondly also be actuated independently from one another, in a manner which is limited by way of the frame device 200. The cars 110 and 120 can therefore be moved relative to one another within the frame device 200 by means of the traction sheave drives 113 and 123. Here, both traction sheave drives 113 and 123 are actuated by the control unit 400.

Here, in particular, the second car 120 is moved relative to the first car 110. For this purpose, car guide elements 230 are arranged within the frame device 200. The said car guide elements 230 are configured as a sliding guide or roller guide and comprise guide rails 232 which are arranged, in particular, on the frame device 200, and guide rollers 221 which are arranged, in particular, on the second car 120.

In an analogous manner to the car guide elements 230, internal counterweight guide elements 330 which comprise guide rollers 331 and guide rails 332 are arranged within the first counterweight 301. Here, the guide rails 332 are arranged, in particular, on an inner side of the first counterweight 301, and the guide rollers 331 are arranged on the second counterweight 302.

If the second car 120 is moved relative to the first car 110 within the frame device 200, the second counterweight 302 is therefore also moved relative to the first counterweight 301 within the first counterweight 301.

In an analogous manner to the frame device guide 220, external counterweight guide elements 320 which comprise guide rollers 321 and guide rails 322 are arranged within the lift shaft 101. The guide rails 322 are arranged, in particular, on the shaft wall 101a of the lift shaft 101, and the guide rollers 321 are arranged, in particular, on the first counterweight.

If the first car 110 and the second car 120 are moved together with the frame device 200 along the frame device guide 220 within the lift shaft 101, the counterweights 301 and 302 are also moved along the external counterweight guide elements 320 within the lift shaft 101.

At its lower end, the lift shaft 101 has an alternative stopping place 500 or a removal floor 500. The said removal floor 500 is shown merely by way of example in FIG. 1. According to one preferred refinement of the invention, the lower car 120 can be removed, dismantled from the frame device 200 and taken out of operation.

Here, the control unit 400 moves the cars 110 and 120 onto the removal floor 500. The frame device 200 is not closed within itself and has an opening 201 at its lower end. Through the said opening 201, the second car 120 is dismantled from the frame device 200 and removed on the removal floor 500.

By means of a fixing element 510, the second suspension means 122 is hooked in and is fixed to the shaft wall 101a of the lift shaft 101. The second suspension means 122 is therefore likewise dismantled from the frame device 200 and removed.

The first car 110 with the frame device 200 is then moved upwards again within the lift shaft 101. The second car 120 is stored on the removal floor 500.

### LIST OF REFERENCE NUMERALS

100 Lift system
101 Lift shaft
101a Shaft wall
105 Upper region of the lift shaft, shaft top
110 First car
111 Suspension means mounting
112 First suspension means
113 First traction sheave drive
120 Second car
121a Guide rollers
121b Quasi-static rollers
122 Second suspension means
123 Second traction sheave drive
200 Frame device, lift cage frame
201 Opening
205 Upper region of the frame device
220 Frame device guide
221 Guide rollers
222 Guide rails
230 Car guide elements
231 Guide rollers
232 Guide rails
301 First counterweight
302 Second counterweight
320 External counterweight guide elements
321 Guide rollers
322 Guide rails
330 Internal counterweight guide elements
331 Guide rollers
332 Guide rails
400 Control unit
500 Removal floor, alternative stopping place
510 Fixing element

1-15. (canceled)

16. A lift system comprising:
at least two cars that are movable in a lift shaft;
at least two drives, each drive being configured to drive one of the at least two cars for movement within the lift shaft; and
a frame device that is movable in the lift shaft, wherein the at least two cars are positioned within the frame device, wherein the at least two cars are movable relative to one another within the frame device by way of the at least two drives.

17. The lift system of claim 16 further comprising a suspension means for each of the at least two cars, wherein the suspension means are guided along the frame device.

18. The lift system of claim 17 wherein the suspension means are combined in a substantially-centered manner in an upper region of the lift shaft.

19. The lift system of claim 16 further comprising car guide elements disposed between the frame device and the at least two cars, wherein the at least two cars are movable relative to one another within the frame device along the car guide elements.

20. The lift system of claim 16 further comprising at least two counterweights, wherein each of the at least two cars is connected respectively to one of the at least two counterweights.

21. The lift system of claim 20 wherein the at least two counterweights comprise a first counterweight and a second counterweight, wherein the second counterweight is disposed within the first counterweight, where the second counterweight is movable within the first counterweight.

22. The lift system of claim 21 wherein the second counterweight is movable within the first counterweight along internal counterweight guide elements that are disposed between the first and second counterweights.

23. The lift system of claim 21 wherein the first and second counterweights are movable jointly within the lift shaft along external counterweight guide elements disposed within the lift shaft.

24. The lift system of claim 16 wherein at least one of the at least two cars is removable from the frame device.

25. The lift system of claim 24 further comprising a fixing element that is configured to fix the suspension means to the lift shaft.

26. The lift system of claim 16 further comprising a passive buffer element disposed between the at least two cars within the frame device.

27. The lift system of claim 16 wherein the frame device is configured as a lift cage frame of one of the at least two cars.

28. A method for operating a lift system including a first car and a second car that are movable within a lift shaft, the method comprising:
arranging the first and second cars within a frame device that is movable in the lift shaft; and
driving the first and second cars relative to one another within the frame device by way of a first drive corresponding to the first car and a second drive corresponding to the second car.

29. The method of claim 28 further comprising:
removing at least one of the first or second cars from the frame device; and
securing suspension means assigned to a car or cars that are removed to the lift shaft.

30. A lift system comprising:
a first car that is movable in a lift shaft;
a second car that is movable in the lift shaft;
a first drive configured to drive the first car for movement within the lift shaft;
a second drive configured to drive the second car for movement within the lift shaft, wherein the first and second cars are movable relative to one another; and
a frame device that is movable in the lift shaft, wherein the first car is secured to the frame device and the second car is positionable within the frame device.

31. The lift system of claim 30 further comprising a first suspension for the first car and a second suspension for the second car, with at least one of the first or second suspensions being guided along the frame device.

32. The lift system of claim 31 wherein the first and second suspensions are combined in a substantially-centered manner in an upper region of the lift shaft.

33. The lift system of claim 30 further comprising car guide elements disposed between the frame device and the first and second cars, wherein the first and second cars are movable relative to one another within the frame device along the car guide elements.

34. The lift system of claim 30 further comprising a first counterweight that is connected to the first car and a second counterweight that is connected to the second car.

35. The lift system of claim 34 wherein the second counterweight is movable within the first counterweight along internal counterweight guide elements that are disposed between the first and second counterweights.
